(19) United States
(12) Patent Application Publication
(10) Pub. No.: US 2007/0250479 A1
(43) Pub. Date: Oct. 25, 2007

(54) System and Method For Facilitating Collaborative Generation of Life Stories

(76) Inventors: Christopher Lunt, Mountain View, CA (US); Andrew Halliday, Soquel, CA (US); Tim Correia, Dublin, CA (US); Dean Pfutzenreuter, Sunnyvale, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/383,134

(22) Filed: May 12, 2006

Related U.S. Application Data
(60) Provisional application No. 60/745,231, filed on Apr. 20, 2006.

(51) Int. Cl. G06F 17/30; G06F 17/00

(52) U.S. Cl. 707/3; 707/1; 707/5; 715/530; 707/104.1

(57) ABSTRACT

Content that has been entered by a user for one purpose is used to generate new content for the user's life story collection. This facilitates the generation of relevant content in a life story collection system. In one example, a user enters a text narrative of a life story and that text narrative is used to generate one or more images that can be added to the life story. In another example, e-mail communication between two users is parsed and transformed into content that can be added to the life stories of the users. In still another example, a comment made by a user to life stories of another user is parsed and transformed into content that can be added to the life story of the user.

### CROSS-REFERENCE TO RELATED APPLICATION

This application claims the benefit of U.S. Provisional Patent Application Ser. No. 60/745,231, entitled “Collaborative System and Method for Generating Biographical Accounts,” filed Apr. 20, 2006, which is herein incorporated by reference.

### BACKGROUND OF THE INVENTION

1 Field of the Invention

The present invention relates generally to methods for generating content for a life story collection system and, more particularly, to methods that facilitate the creation of content by users of the life collection system.

2. Description of the Related Art

Many web sites today rely on users to create and organize the content that are made available on their web sites. In general, these web sites provide a software platform that encourages user participation through creation, organization and sharing of content. Rather than focusing on the creation of the content that is available on their web sites, their focus has been on providing the facilities and framework for users to publish their own content.

The attractiveness of these web sites is their potential ability to grow the user base exponentially through viral marketing and to leverage the entire user base to supply and organize relevant content. The objective is to have much of the marketing of the web site and the creation and organization of the content on the web site be carried out by the users themselves, so that the cost of operating such a web site can be kept very low.

Some of the more popular technologies that have been developed to enable the creation, organization and sharing at these web sites include blogging, podcasting, RSS feeds, wikis, and tags. Blogging provides users with a platform and tools to compose content for sharing with other users. Podcasting provides users with a platform and tools to select and organize multimedia content to be shared with other users. RSS feeds are used by these web sites to receive summaries of web content together with links to the full versions of the content from other web sites. Wikis provide a common platform for a group of users to collaborate in the generation of content. Tags are user-defined keywords for classifying content and are used to organize content created and published by users.

### SUMMARY OF THE INVENTION

The present invention provides additional tools for helping users create web site content. In particular, the present invention provides methods for facilitating creation of content for a user's life story collection. The methods according to embodiments of the present invention apply content that has been entered by a user for one purpose to generate new content to be added to the user's life story collection.

According to a first embodiment of the invention, a user enters a text narrative of a life story and that text narrative is used to generate one or more images that can be added to the life story. In particular, this method includes the steps of receiving a text narrative of the life story from the user, generating a search query based on the context of the text narrative, and performing an image search using the search query to generate one or more images to be added to the content relating to the life story.

The method according to further embodiments of the invention are directed to generating content for a life story collection of a first user based on collaborative activities between the first user and a second user. This method includes the steps of preparing content submitted by the second user for viewing by the first user, transmitting the prepared content to the first user, receiving content submitted by the first user in response to the content submitted by the second user, and parsing the received content and generating new content to be added to the life story collection of the first user using the parsed content.

In one example, the prepared content may be an e-mail communication from the second user to the first user, and the content submitted by the first user may be a reply e-mail communication from the first user to the second user. In other words, e-mail communication between two users is parsed and transformed into content that can be added to the life stories of the users.

In another example, the prepared content may be content relating to a life story of the second user, and the content submitted by the first user may be a comment to the life story of the second user. Here, a comment made by a user to life stories of another user is parsed and transformed into content that can be added to the life story of the user.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a networked computer environment in which systems and methods according to embodiments of the present invention may be implemented.

FIG. 2 is a schematic representation of a sample web page that is displayed to a user when the user logs into the web site that manages many of the features of the present invention.

FIGS. 3A-F are schematic representations of web pages that are used in posting life stories to the web site.

FIG. 4 is a schematic representation of a web page that is used in managing a user's connections.

FIG. 5 is a flow diagram that illustrates the method steps carried out to generate new content relating to a life story from a text narrative of the life story.

FIG. 6 is a flow diagram that illustrates the method steps carried out to generate new content relating to a life story from an e-mail communication.

FIG. 7 is a flow diagram that illustrates the method steps carried out to generate new content relating to a life story of one user from comments made to a life story of another user.

### DETAILED DESCRIPTION

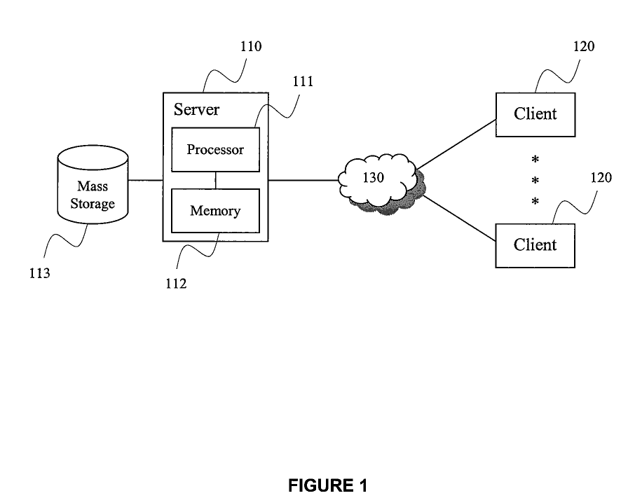

FIG. 1 illustrates a networked computer environment in which systems and methods according to embodiments of the present invention may be implemented. As shown, the networked computer environment includes a server computer 110 and a plurality of client computers 120 (only two of which are shown). The server computer 110 and the client computers 120 are connected over a computer network 130, e.g., the Internet. The components of the server computer 110 that are illustrated in FIG. 1 include a processor 111 and a system memory 112. The server computer 110 is connected to a mass storage unit 113 that stores the contents managed by the server computer 110. Each client computer 120 includes conventional components of a computing device, e.g., a processor, system memory, a hard disk drive, input devices such as a mouse and a keyboard, and output devices such as a monitor (not shown).

The server computer 110 is programmed to operate as a network server that communicates with the client computers 120. In the embodiments of the present invention described herein, the server computer 110 is programmed as a web server that communicates with the client computers 120 using the TCP/IP protocol, and hosts a web site that can be accessed by the client computers 120. The client computers 120 are programmed to execute web browser programs and access the web pages managed by the server computer 110 by specifying a uniform resource locator (URL) for the server computer 110 into the browser.

The server computer 110 manages the contents stored in the mass storage unit 113 using a relational database software. The contents include profile data of the registered users of the web site. The profile data specify: user ID, password, name, e-mail, address including zip code, gender, marital status, date of birth, occupation, a pointer to an image file, various permission settings, and other similar data. The contents further include interview questions, multimedia files such as image files, video files, audio files and flash animation files, life stories posted by the users, commentaries made to the posted life stories, user-defined private circle data, and such other data needed by the server computer 110 to process data received from the users and render web pages requested by the users.

In the embodiments of the present invention described below, users are respectively operating the client computers 120 that are connected to the server computer 110 over the Internet. Also, web pages that are displayed to a user are transmitted from the server computer 110 to that user's client computer 120 and processed by the web browser program stored in that user's client computer 120 for display through the monitor of that user's client computer 120.

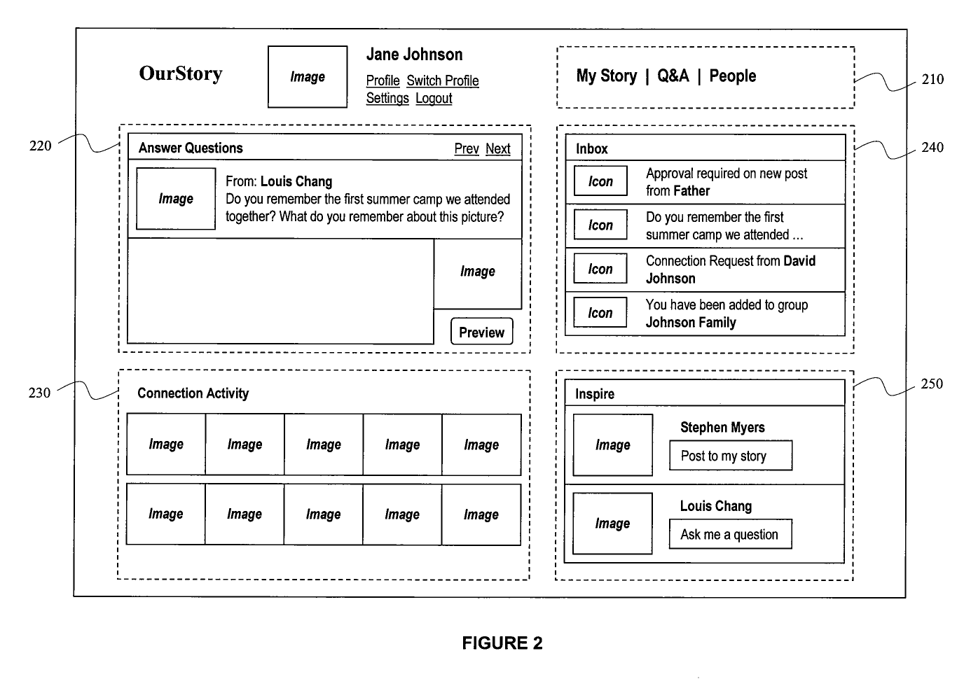

FIG. 2 is a schematic representation of a web page that is generated by the server computer 110 and transmitted to a user for display when the user accesses the web site managed by the server computer 110, and logs in using his or her user ID and password. The web page identifies the web site “OurStory” and the user who logged in with the user's name (Jane Johnson) and the user's image. The user can access her life stories by accessing the My Story hyperlink provided in a navigation section 210 of the web page. Other hyperlinks are provided on the web page to allow the user to view and change her profile (Profile hyperlink) and the account settings (Settings hyperlink).

The web site permits a single registered user to keep multiple profiles and maintain life stories for each person, group, and sometimes fictional characters, represented in the profiles. This feature may be used in situations where it is preferred to write the life stories from a third person point of view, or for a group of people (e.g., the Smith family or the 1980 U.S. Olympic hockey team) or a fictional character, or where the subject of the life stories is not computer sawy. The Switch Profile hyperlink is provided to users who are maintaining multiple profiles to allow such users to switch to another profile and view and manage the life stories of the person, group, or fictional character represented in the other profile.

The web page further provides various other graphical user interface (GUI) elements. They include a navigation section 210, a question section 220, an image gallery 230, an inbox 240, and a collaboration section 250.

The navigation section 210 includes hyperlinks to web pages that are used to view, modify or add to the user's life stories (My Story), interview questions (Q&A), and relationships (People).

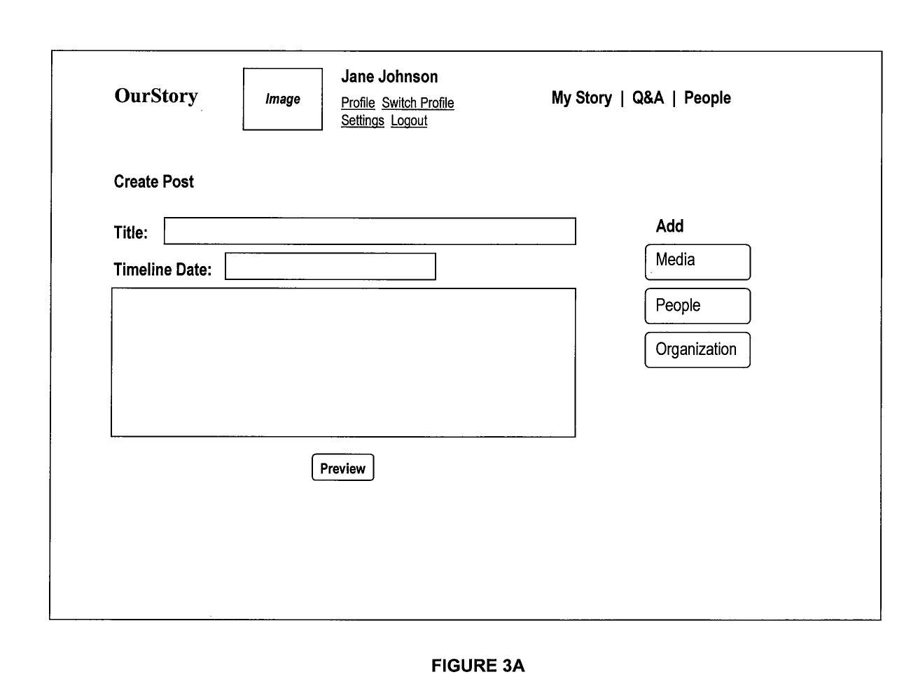

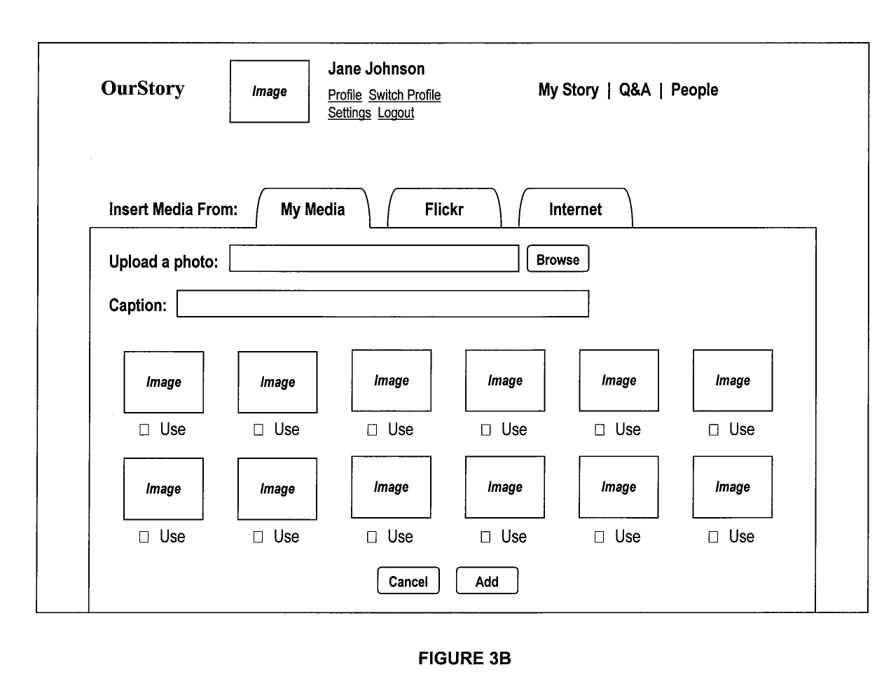

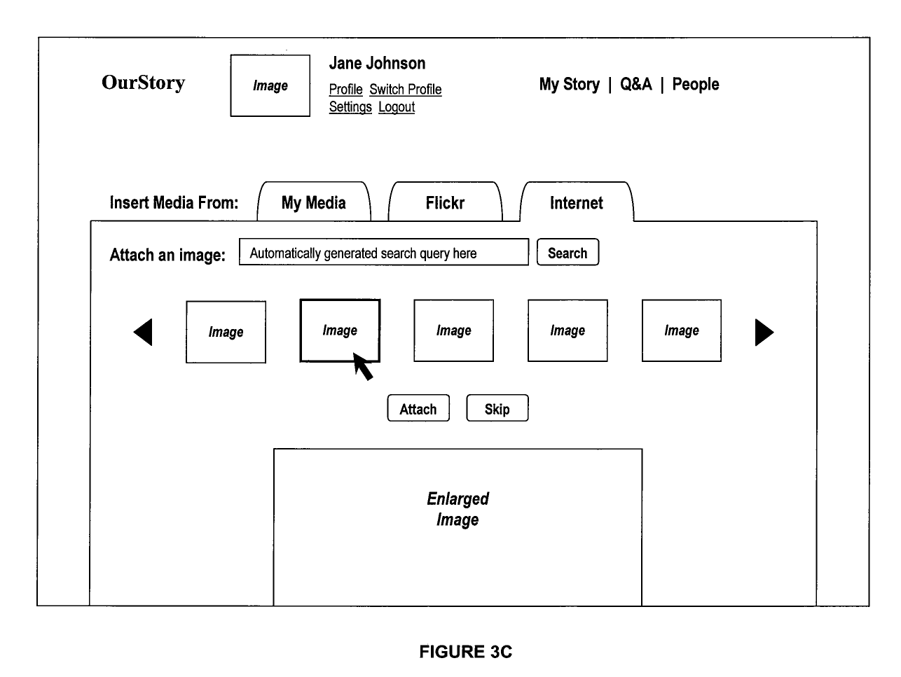

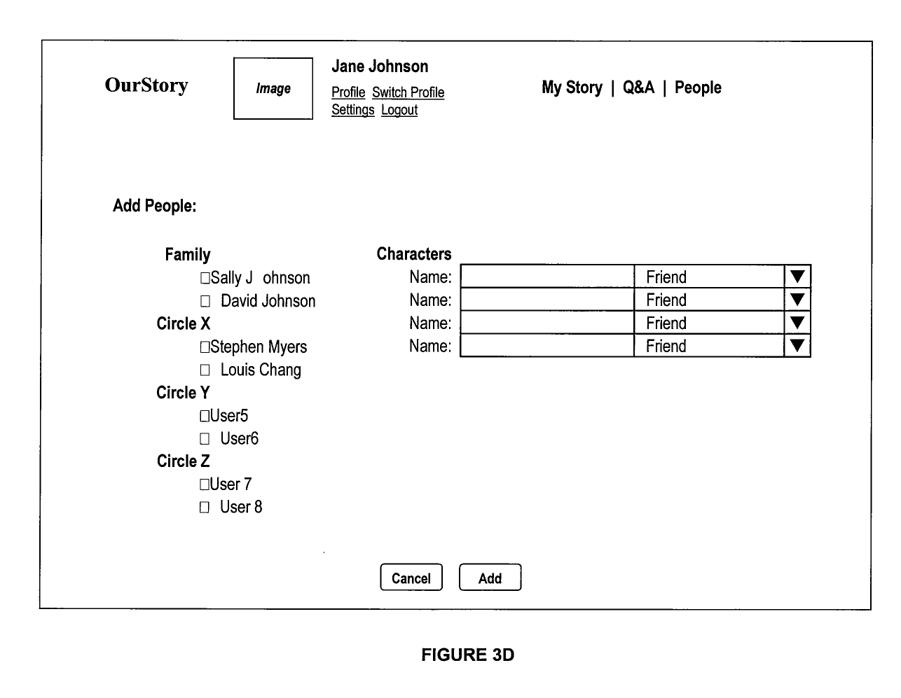

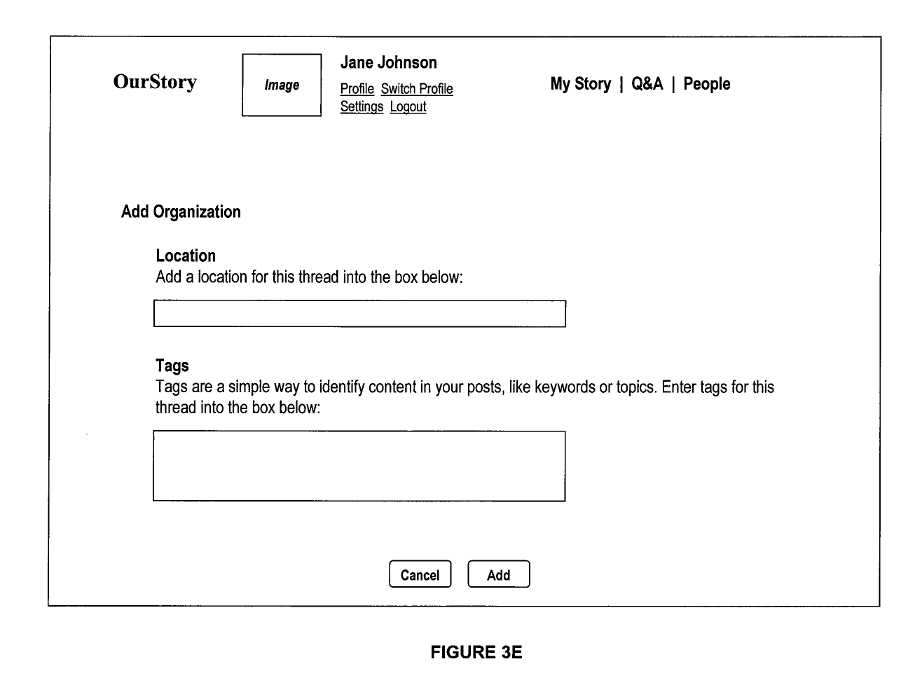

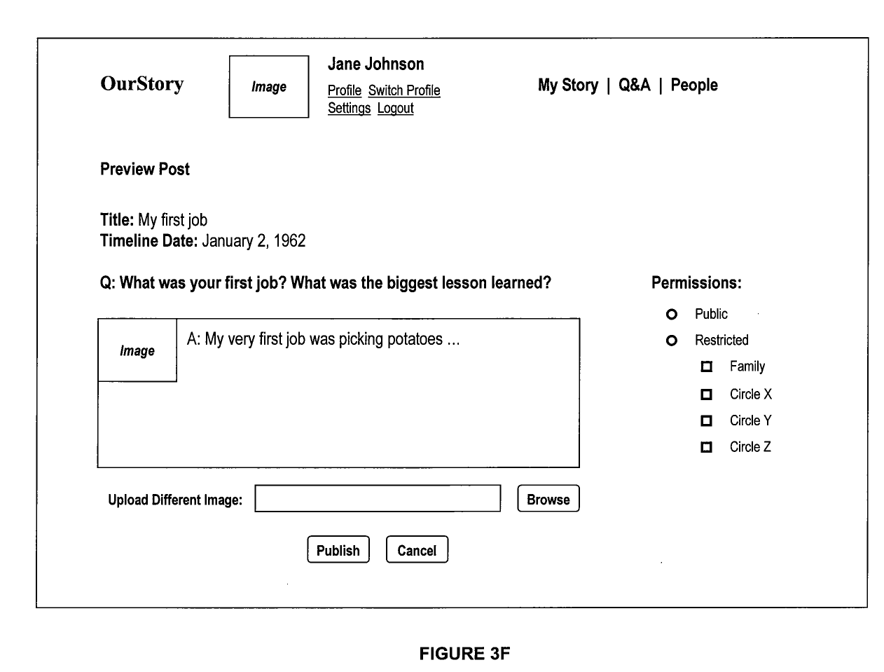

The question section 220 displays the most recent question that has been posed to the user and various other information associated with the question, including the name and image of the person asking the question, any image attached to the question by the person, and a text input field in which the user can answer the question. The question section 220 also provides question navigation hyperlinks “Previous” and “Next” using which the user can turn to the previous question or the next question that is in the queue of questions that have been posed to this user. The input of the answer followed by a click on the Preview button causes the display of a preview web page similar to the one shown in FIG. 3F, using which the user can either publish the answer as a life story or cancel it. If the user publishes the answer, the server computer 110 saves the answer and the associated image in the mass storage unit 113. Further, in response to either the publishing or canceling action, the next question in the queue is displayed to the user. The user may also delete a question from the queue of questions by clicking on the “Delete” hyperlink. In response to this action, the next question in the queue is displayed to the user.

The image gallery 230 provides the user with a pictorial snapshot of the more recent activities by persons who are connected to the user or by those who belong to a special group defined by the user, e.g., the user's immediate family or the user's closest friends. The activities that are tracked by the image gallery 230 include recent posts of life stories by the connected users or members of the special group and recent comments made by them to the user's life stories. The image gallery 230 may also include recent instructional, informational, and inspirational posts submitted by other users and system generated content that are posted to encourage users to post their life stories. A click on any image hyperlinks the user to the thread corresponding to that image. A “thread” consists of a post and any comments made concerning the post.

The inbox 240 displays messages generated by the web site in response to actions taken by the other users of the web site. The messages include notices of actions taken by other users (e.g., “You have been added to group Johnson Family”) and summaries of tasks that the user has been asked to complete (e.g., “Approval required on new post from Father” and “Connection Request from David Johnson”). An icon is displayed alongside each message to help the user quickly identify the content of the message.

The collaboration section 250 provides hyperlinks to a web page used to post a life story on behalf of another user and a web page used to ask questions to another user. The identity of the other user is displayed in this section along with that person's image. Only those users who have given the user sufficient access rights will appear in this section. In the example given here, Jane Johnson has the right to post stories on behalf of Stephen Myers, and Jane Johnson has the right to ask Louis Chang questions.

FIG. 3A is a schematic representation of a GUI that is used for posting life stories. This GUI includes input fields for the title, the date, and the word description for the post. It also includes hyperlinks to web pages for adding media to the post (Media), identifying persons or groups who are part of the story (People), and specifying additional information such as locations and keywords (Organization). The media that is added may be any of the following: (i) images that the user uploaded, (ii) images others have uploaded and shared with the user, (iii) images that are retrieved from an image search conducted on the web based on the context of the post, (iv) images from third party photo sharing sites, (v) video files, (vi) audio files, and (vii) flash animation files.

FIGS. 3B and 3C are schematic representations of the web page for adding media to the post. Three tabs are provided on this page. They are “My Media,” “Flickr,” and “Internet.” FIG. 3B is the web page that is displayed to the user when the My Media tab is selected. FIG. 3C is the web page that is displayed to the user when the Internet tab is selected. The web page of FIG. 3B provides the user the option to upload a new photo and insert a caption for that photo, or use one of the photos that have been previously uploaded into the user's account. The web page of FIG. 3C provides the user with the option of selecting one of the images retrieved from an Internet image search. The query for the Internet image search is automatically generated from the text narrative of the post using a conventional contextual search query generator.

FIG. 3D is a schematic representation of the web page for marking the post with character tags, which are tags that are defined with respect to those persons that are depicted in the text narratives and images. Each character tag is associated with either a user profile or a pseudo-profile. A pseudo-profile typically includes a person's name, and may also include the person's e-mail address and phone number. A pseudo-profile for a person is created by a user when the user does not know if the person has a user profile. FIG. 3D shows, on the left hand side, a list of users who are connected to the user and have user profiles. If any of these users are depicted in the post, the boxes next to their names are checked to indicate the user's intention to mark the post with tags associated with their user profiles. If there are persons depicted in the post and the user does not know if such persons have a user profile, the user has the option of entering the person's name and affiliation (e.g., friend or family) in the Characters input field. When the “Add” button is selected by the user, pseudo-profiles are created for those persons named in the Characters input field. In this example, the pseudo-profile includes the name of the character and affiliation of this character to the user who created it.

A post may also be tagged with the location depicted in the post and keywords defined by the user. The web page for inputting this data is shown in schematically FIG. 3E. When the “Add” button is selected by the user, the post is tagged with the location and keywords entered by the user.

The table below shows conceptually how the server computer 110 keeps track of the different tags that are associated with different posts or objects. The starred names under the column, “Character Tags,” represent the persons for whom pseudo-profiles have been created.

| Object | Date | Keyword Tags | Character Tags | Location |
|---|---|---|---|---|
| Post 1123 | Jun. 1, 1980 | childhood, baseball | Father, Jay Smith* | Miami, FL |
| Post 1124 | Oct. 10, 1998 | career, Internet | Louis Chang, Carl Jones* | Santa Clara, CA |
| Image 2122 | Aug. 5, 2001 | daughter, walking | Daughter, Wife, Mother | Sunnyvale, CA |
| Image 2123 | Dec. 11, 2003 | son, basketball | Father, Stephen Brown* | Sunnyvale, CA |

When the user selects the Add button or the Cancel button from the media, people, and organization web pages, shown schematically in FIGS. 3B-C, 3D, and 3E, respectively, the user is returned to the web page of 3A. When the user is finished with his or her inputs, the user clicks on the Preview button, in response to which a Preview Post web page like the one shown in FIG. 3F is displayed to the user. The user can specify permissions levels for viewing and commenting on this post on this web page. A public permissions level allows any user to view and comment on this post. A restricted permissions level allows only those users who are in the groups that have been checked to view and comment on this post. When the user clicks on the Publish button, the data relating to this post, including the word description, the attached media file, the permissions level settings, and other data specified using the web pages accessed through the Media, People and Organization hyperlinks, are transmitted to the server computer 110 along with data that identifies the person who is the subject of this life story. The identifying data may be the user ID of the person submitting the life story or the user ID of the person on behalf of whom the life story is submitted. In the case where a single user is maintaining multiple profiles and their stories and the user is submitting a story for one of these profiles, the identifying data may be an ID corresponding to that profile.

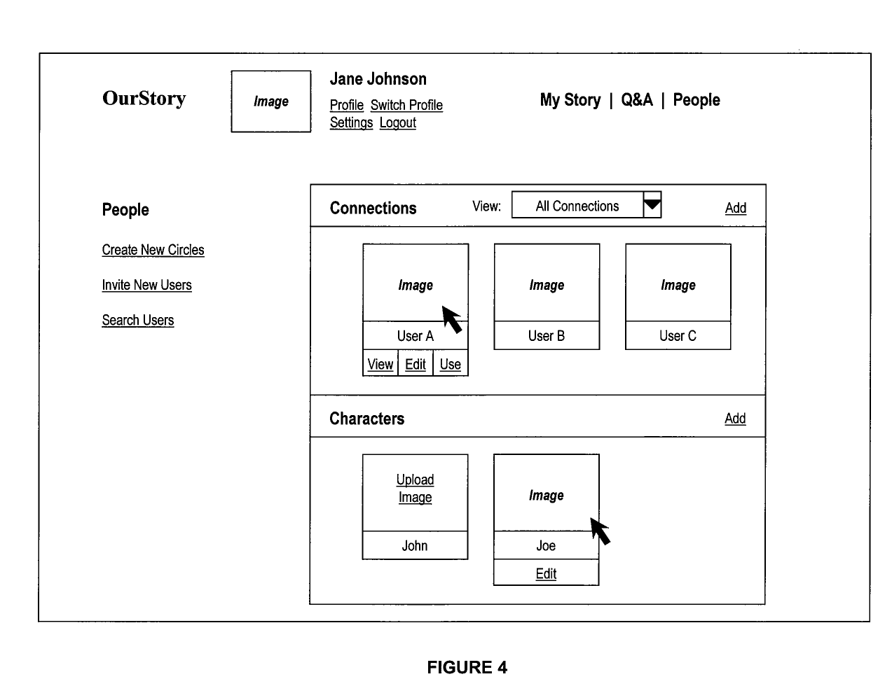

FIG. 4 is a schematic representation of the web page that is generated by the server computer 110 and transmitted to a user for display when the user selects the People hyperlink from the navigation section 210. The web page provides hyperlinks to web pages for defining new private circles, and populating them with users (Create New Circles), managing invitations (Invite New Users), and performing searches of other registered users of the web site (Search Users). It also includes an image gallery of users who are connected to the user, and characters created by the user. A connection to the user by another user exists or can be made by: (i) the user was invited by the other user or invited the other user onto the web site; or (ii) the user places the other user into one of his or her circles.

The users shown in the Connections window of the web page in FIG. 4 represent all users of the web site that are connected to the user. The View drop-down menu includes selections of user-defined private circles. The members that are displayed in the Connections window may be changed based on the selection made using the View drop-down menu. Also, once the display has changed to a selected private circle, other users may be added to the private circle through the Add hyperlink.

When a mouse pointer hovers over a user name or image displayed inside the Connections window, three selectable hyperlinks (View, Edit and Use) appear at the bottom of the user's name. The View hyperlink accesses the My Story web page of this user. The Edit hyperlink allows this user's displayed name or image to be changed. The Use hyperlink accesses the GUI of FIG. 3A using which a life story may be posted on behalf of this user.

The users shown in the Characters window of the web page in FIG. 4 represent those persons for whom pseudo-profiles have been created. An image may or may not be available. If an image is not available, an Upload Image hyperlink is displayed. When a mouse pointer hovers over a name or image displayed inside the Characters window, an Edit hyperlink appears at the bottom of the user's name. The Edit hyperlink is accessed to edit the name of the character, upload an image, or to edit or enter other pseudo-profile data, e.g., e-mail address and telephone number.

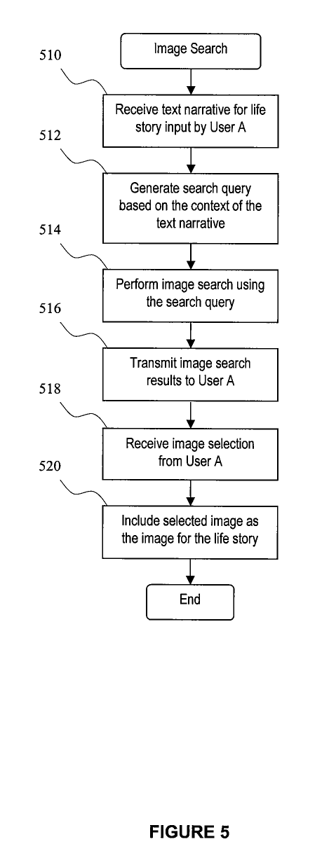

According to a first embodiment of the invention, a user enters a text narrative of a life story and that text narrative is used to generate one or more images that can be added to the life story. FIG. 5 is a flow diagram that illustrates the steps of this method. In the example given herein, User A enters a text narrative of a life story using the GUI of FIG. 3A, and clicks on the Media hyperlink, which transports User A to the GUI of FIG. 3C.

When User A clicks on the Media hyperlink, the server computer 110 receives the text narrative entered by User A (step 510). Then, the server computer 110 generates a search query based on the context of the text narrative (step 512). The search query is automatically generated from the text narrative using a conventional contextual search query generator. In step 514, an image search is performed using the search query generated in step 512. The image search may be carried out by the server computer 110 or, more preferably, another computer which has been configured to carry out Internet image searches, e.g., a third party Internet image search engine. In the latter case, the server computer 110 passes on the search query generated in step 512 to the third party Internet image search engine and receives images search results therefrom. In step 516, the server computer 110 prepares a web page from the image search results (like the one shown in FIG. 3C) and transmits the web page to User A. When User A selects one or more of the images, the selection data is received by the server computer 110 (step 518), which then includes the selected image(s) as part of the content relating to User A's life story (step 520).

The method according to further embodiments of the invention are directed to generating content for a life story collection of a first user based on collaborative activities between the first user and a second user. In one example, e-mail communication between two users is parsed and transformed into content that can be added to the life stories of the users. In another example, a comment made by a user to life stories of another user is parsed and transformed into content that can be added to the life story of the user.

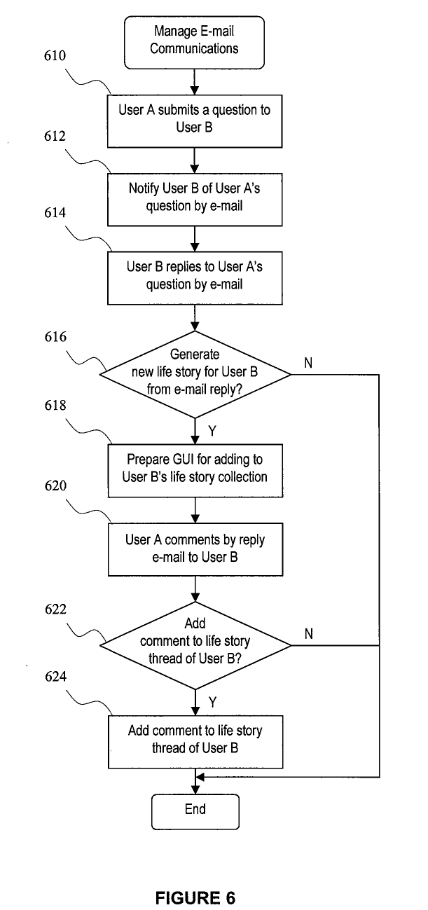

The flow diagram shown in FIG. 6 illustrates the steps of the method for generating new content for a life story collection from e-mail communications between User A and User B. In step 610, User A submits a question to User B. This may be done through the “Ask me a question” button provided in the collaboration section 250 shown in FIG. 2, the Q&A hyperlink provided in the navigation section 210, or from the My Story web page of User B. The submission of this question causes the server computer 110 to place this question in the question queue and inbox of User B and to generate an e-mail communication addressed from User A to User B (step 612). When User B replies to this e-mail communication through a reply e-mail (step 614), User B is asked if he or she would like to use the content of the reply e-mail to generate a new life story to add to his or her life story collection (step 616). If the answer is “Yes,” the server computer 110 parses the content of the reply e-mail to generate a GUI like the one shown in FIG. 3F for display to User B (step 618). User B may then edit the contents of the life story using this GUI before publishing it as part of his or her life story collection. If the answer is “No,” the process ends.

In some instances, user A might comment on User B's reply e-mail through another e-mail communication (step 620). When this happens and a life story thread has been created based on User B's reply e-mail, User A is asked if he or she would like to use the content of this e-mail communication to generate a comment to add to User B's life story thread (step 622). If the answer is “Yes,” the server computer 110 parses the content of the e-mail communication and adds the comment to User B's life story thread (step 624). If the answer is “No,” the process ends.

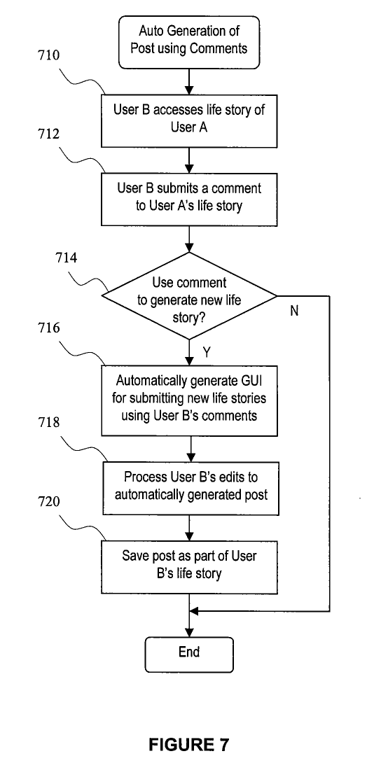

The flow diagram shown in FIG. 7 illustrates the steps of the method for generating new content for a life story collection for User B from a comment made by User B to a life story of User A. In step 710, User B accesses and views a life story of User A. This may be done by clicking on an image relating to a life story posted by User A in the image gallery section 230 shown in FIG. 2 or from the My Story web page of User A. User B then submits a comment to User A's life story (step 712). The comment includes a text narrative and optionally an image. Upon submission of the comment, User B is asked if User B would like to use the comment to generate a new life story for his or her life story collection (step 714). If the answer is “Yes,” the server computer 110 in step 716 parses the submitted content and automatically generates a GUI like the one shown in FIG. 3F for display to User B. After User B edits the contents of the life story displayed in the GUI and clicks on the Publish button, the server computer 110 processes the edits (step 718) and saves the post as part of User B's life story (step 720). If the answer is “No,” the process ends.

While particular embodiments according to the invention have been illustrated and described above, those skilled in the art understand that the invention can take a variety of forms and embodiments within the scope of the appended claims.

What is claimed is:

1. A method for generating content for a life story collection, comprising the steps of:
receiving content that has been entered through a user interface configured to support a predetermined user activity;
storing the content in accordance with the predetermined user activity; and
parsing the content and generating new content for a life story collection using the parsed content.

2. The method according to claim 1, wherein the predetermined user activity comprises adding a text narrative to a life story collection and the received and stored content comprises the text narrative, and wherein the step of generating new content includes the steps of:
constructing a search query from the parsed content; and
performing an image search using the search query to generate at least one image to be added as the new content for the life story collection.

3. The method according to claim 2, wherein the step of performing an image search includes issuing the search query to a third party image search provider and receiving image search results from the third party image search provider, and wherein the new content is included in one of the image search results.

4. The method according to claim 1, wherein the predetermined user activity comprises exchanging e-mail communications, and the new content includes a text narrative of an event that has been parsed from one of the e-mail communications.

5. The method according to claim 4, wherein the new content further includes an interview question in response to which the text narrative of the event was composed, the question also being parsed from one of the e-mail communications.

6. The method according to claim 1, wherein the predetermined user activity comprises a first user adding a comment to a second user's life story, and the new content includes a text narrative for the first user's life story that has been parsed from the first user's comment to the second user's life story.

7. The method according to claim 6, further comprising the step of preparing a user interface for the first user, the user interface including a editable text window for displaying the text narrative for the first user's life story using which the first user can modify the text narrative before adding the text narrative to the first user's life story collection.

8. A method for adding images to content relating to a life story, comprising the steps of:
receiving a text narrative of the life story;
generating a search query based on the context of the text narrative; and
performing an image search using the search query to generate at least one image to be added to the content relating to the life story.

9. The method according to claim 8, wherein the step of performing an image search includes the steps of issuing the search query to a third party image search provider and receiving image search results that includes said at least one image to be added, from the third party image search provider.

10. The method according to claim 8, further comprising the steps of:
preparing a user interface including a plurality of images obtained from the image search;
receiving a selection of at least one of the images; and
adding said at least one of the images to the content relating to the life story.

11. The method according to claim 10, wherein the user interface includes a section for displaying thumbnail images, user interface controls for enabling the user to scroll through the thumbnail images, and a section for displaying an enlarged version of one of the thumbnail images.

12. A method for generating content to be added to a life story collection of a first user based on collaborative activities between the first user and a second user, said method comprising the steps of:
preparing content submitted by the second user for viewing by the first user;
transmitting the prepared content to the first user;
receiving content submitted by the first user in response to the content submitted by the second user;
parsing the received content and generating new content to be added to the life story collection of the first user using the parsed content.

13. The method according to claim 12, wherein the prepared content comprises an e-mail communication from the second user to the first user, and the content submitted by the first user comprises a reply e-mail communication from the first user to the second user.

14. The method according to claim 13, wherein the e-mail communication comprises an interview question posed to the first user by the second user and the new content is generated from the reply e-mail communication and includes a text narrative for a life story of the first user parsed from the reply e-mail communication.

15. The method according to claim 14, further comprising the steps of:
receiving additional content submitted by the second user in response to the reply e-mail communication; and
parsing the received additional content and generating additional new content to be added to the life story collection of the first user using the parsed additional content.

16. The method according to claim 13, further comprising the step of determining whether the e-mail communication is to be prepared and transmitted to the first user based on a notification setting specified by the first user.

17. The method according to claim 12, wherein the prepared content comprises content relating to a life story of the second user, and the content submitted by the first user comprises a comment to the life story of the second user.

18. The method according to claim 17, wherein the new content is generated from the comment and includes a text narrative parsed from the comment.

19. The method according to claim 18, further comprising the step of preparing a graphical user interface for the first user, the user interface including an editable text window for displaying the text narrative using which the first user can modify the text narrative before adding the text narrative to the first user's life story collection.

20. The method according to claim 17, further comprising the step of receiving a confirmation from the first user to use the comment as the new content for the first user's life story collection.
